(19) United States
(12) Patent Application Publication
(10) Pub. No.: US 2013/0166320 A1
(43) Pub. Date: Jun. 27, 2013

(54) PATIENT-CENTRIC INFORMATION MANAGEMENT

(71) Applicants: Ilya Kupershmidt, San Francisco, CA (US); Qiaojuan Jane Su, San Jose, CA (US)

(72) Inventors: Ilya Kupershmidt, San Francisco, CA (US); Qiaojuan Jane Su, San Jose, CA (US)

(73) Assignee: NEXTBIO, Santa Clara, CA (US)

(21) Appl. No.: 13/621,756

(22) Filed: Sep. 17, 2012

Related U.S. Application Data
(60) Provisional application No. 61/535,317, filed on Sep. 15, 2011.

(51) Int. Cl. G06F 19/00; G06Q 50/22

(52) U.S. Cl. CPC G06F 19/322; G06Q 50/22
USPC 705/3

(57) ABSTRACT

Provided herein are methods, systems and apparatus for querying and interpreting data derived from individual patients. The methods, systems and apparatus described herein can be used in clinical and research settings. Included are methods, systems and apparatus for identifying similar patients, germline DNA analysis, somatic tissue analysis, pathway-based therapy selection, prioritizing drugs, and querying a database to return patients and clinical attributes.

### CROSS-REFERENCE TO RELATED APPLICATION

This application claims benefit under 35 USC §119(e) of U.S. Provisional Patent Application No. 61/535,317, filed Sep. 15, 2011, which is incorporated by reference herein.

### BACKGROUND OF THE INVENTION

The present invention relates generally to methods, systems and apparatus for storing and retrieving biological, chemical and medical information of patients. An enormous amount of data can be available to a researcher or clinician from various assay platforms, data types, etc. Researchers and clinicians need fast and efficient tools to quickly assimilate new information and integrate it with pre-existing information across different platforms, organisms, etc., and tools to quickly navigate through and analyze diverse types of information.

### SUMMARY

The present invention relates to methods, systems and apparatus for querying and interpreting data derived from individual patients. The methods, systems and apparatus described herein can be used in clinical and research settings. Included are methods, systems and apparatus for identifying similar patients, germline DNA analysis, somatic tissue analysis, pathway-based therapy selection, prioritizing drugs, and querying a database to return patients and clinical attributes.

### BRIEF DESCRIPTION OF THE DRAWINGS

FIG. 1 shows an overview of a process of integrating patient-centric information into a knowledge base according to various embodiments.

FIG. 2 provides a schematic depiction of different molecular profiles associated with a patient.

FIG. 3 shows an overview of a process of importing a patient-centric feature set into a knowledge base according to various embodiments.

FIG. 4 shows an overview of certain operations in processes of scoring a patients' information with other information in the knowledge base.

FIG. 5 shows a representation of various elements in a knowledge base including patient information.

FIG. 6 provides a screenshot showing different mutation classes and associated ranks for certain variants in a feature set.

FIG. 7 shows an overview of a process of performing a feature group enrichment algorithm according to certain embodiments.

FIG. 8a shows an overview of a process of identifying impacted phenotypes based on a patient's variants according to certain embodiments.

FIG. 8b shows an example of determining an association between a variant V₁ and a phenotype D_{A} based on multiple criteria.

FIG. 9a shows an overview of an example of a process to identify impacted tissues based on a variants in a patient's genome.

FIG. 9b shows an example of determining an association of variant V₁ with tissue T_{A}.

FIG. 10 shows a screenshot showing an example output of impacted tissues based on the germline DNA analysis.

FIG. 11 shows an example patient report based on genome variants from a patient's melanoma tumor.

FIG. 12 shows an example of a ranked list of clinical attributes resulting from a query of a patient's somatic genome (feature set) against all patients having glioblastoma.

FIG. 13 is a screenshot showing an example of an interface.

FIG. 14 illustrates, in simple block format, a typical computer system that, when appropriately configured or designed, can serve as a computational apparatus according to certain embodiments.

FIGS. 15 and 16 provide set diagram showing an example of a Feature Set versus Feature Set relationship and Feature Set versus Feature Group relationships that may be used to determine correlations in certain embodiments.

FIGS. 17A-17C provide overviews of process flows for returning ranked lists of feature sets (patients) in response to various queries.

### DETAILED DESCRIPTION

### 1. Introduction and Relevant Terminology

The present invention relates to methods, systems and apparatus for querying and interpreting data derived from individual patients. The methods, systems and apparatus described herein can be used in clinical and research settings. Included are methods, systems and apparatus for identifying similar patients, germline DNA analysis, somatic tissue analysis, pathway-based therapy selection, prioritizing drugs, and querying a database to return patients and clinical attributes.

The following terms are used throughout the specification. The descriptions are provided to assist in understanding the specification, but do not necessarily limit the scope of the invention.

Raw data—This is the data from one or more experiments or assays that provides information about one or more samples. Typically, raw data may not yet processed to a point suitable for use in the databases and systems of this invention. Subsequent manipulation reduces it to the form of one or more “feature sets” suitable for use in such databases and systems. Examples of platforms used to produce raw data include, but are not limited to, microarray platforms including RNA and miRNA expression, SNP genotyping, protein expression, protein-DNA interaction and methylation data and amplification/deletion of chromosomal regions platforms, quantitative polymerase chain reaction (QPCR) gene expression platforms, identified novel genetic variants, copy-number variation (CNV) detection platforms, detecting chromosomal aberrations (amplifications/deletions) and whole genome sequencing. Most of the examples presented herein concern profiles of one or more samples of a patient using molecular profiling technology. For example, a given patient's lung tumor sample can be analyzed at the level of DNA (somatic mutations and structural rearrangements), RNA and miRNA expression, DNA methylation, proteomics and metabolomics. Each of these molecular profiles can result in an individual Feature Set. Often the raw data will have associated clinical information such as tumor stage, patient history, patient age, patient gender, time to survival, etc. As suggested, the raw data will include “features.” Examples of features include genes from a particular tissue or cell sample, sequence regions, mutations or variations, etc. Other types of genetic features for which experimental information may be collected in raw data include SNP patterns (e.g., haplotype blocks), portions of genes (e.g., exons/introns or regulatory motifs), regions of a genome of chromosome spanning more than one gene, etc. Other types of biological features include phenotypic features such as the morphology of cells and cellular organelles such as nuclei, Golgi, etc. Types of chemical features include compounds, metabolites, etc. While most of the examples described herein concern raw data related to a patient, a database described herein may include information derived from raw data produced one or more other chemical, biological or clinical experiments.

Feature set—This refers to a data set derived from the “raw data” taken from one or more assays on one or more samples. In certain embodiments, the feature set includes one or more features (typically a plurality of features) and associated statistical information. The features of a feature set may be ranked with a ranking indicating the relative importance of a feature in the particular assay or profile. In certain embodiments, features can be ranked based on their relative levels of response to the stimulus or treatment in an experiment or based on their magnitude and direction of change between different phenotypes, as well as their ability to differentiate different phenotypic states (e.g., late tumor stage versus early tumor stage). In an example, a feature set may include genes and expression levels, or genes and ranks based on the expression levels. For reasons of storage and computational efficiency, for example, the feature set may include information about only a subset of the features or responses contained in the raw data. As indicated, a process such as curation converts raw data to feature sets.

In certain embodiments, the feature set pertains to raw data associated with a particular question or issue (e.g., does a particular chemical compound interact with proteins in a particular pathway). Depending on the raw data and the study, the feature set may be limited to a single cell type of a single organism. From the perspective of a “Directory,” a feature set belongs to a “Study.” In other words, a single study may include one or more feature sets.

In many embodiments, the feature set is either a “bioset” or a “chemset.” A bioset typically contains data providing information about the biological impact of a particular stimulus or treatment. The features of a bioset are typically units of genetic or phenotypic information as presented above. These are ranked based on their level of response to the stimulus (e.g., a degree of up or down regulation in expression), or based on their magnitude and direction of change between different phenotypes, as well as their ability to differentiate different phenotypic states (e.g., late tumor stage versus early tumor stage). A chemset typically contains data about a panel of chemical compounds and how they interact with a sample, such as a biological sample. The features of a chemset are typically individual chemical compounds or concentrations of particular chemical compounds. The associated information about these features may be EC50 values, IC50 values, or the like.

A feature set typically includes, in addition to the identities of one or more features, statistical information about each feature and possibly common names or other information about each feature. A feature set may include still other pieces of information for each feature such as associated description of key features, user-based annotations, etc. The statistical information may include p-values of data for features (from the data curation stage), “fold change” data, and the like. A fold change indicates the number of times (fold) that expression is increased or decreased in the test or control experiment (e.g., a particular gene's expression increased “4-fold” in response to a treatment). A feature set may also contain features that represent a “normal state”, rather than an indication of change. For example, a feature set may contain a set of genes that have “normal and uniform” expression levels across a majority of human tissues. In this case, the feature set would not necessarily indicate change, but rather a lack thereof.

In certain embodiments, a rank is ascribed to each feature, at least temporarily. This may be simply a measure of relative response within the group of features in the feature set. As an example, the rank may be a measure of the relative difference in expression (up or down regulation) between the features of a control and a test experiment. In certain embodiments, the rank is independent of the absolute value of the feature response. Thus, for example, one feature set may have a feature ranked number two that has a 1.5 fold increase in response, while a different feature set has the same feature ranked number ten that has a 5 fold increase in response to a different stimulus.

Directional feature set—A directional feature set is a feature set that contains information about the direction of change in a feature relative to a control. Bi-directional feature sets, for example, contain information about which features are up-regulated and which features are down-regulated in response to a control. One example of a bi-directional feature set is a gene expression profile that contains information about up and down regulated genes in a particular disease state relative to normal state, or in a treated sample relative to non-treated. As used herein, the terms “up-regulated” and “down-regulated” and similar terms are not limited to gene or protein expression, but include any differential impact or response of a feature. Examples include, but are not limited to, biological impact of chemical compounds or other stimulus as manifested as a change in a feature such as a level of gene expression or a phenotypic characteristic.

Non-directional feature sets contain features without indication of a direction of change of that feature. This includes gene expression, as well as different biological measurements in which some type of biological response is measured. For example, a non-directional feature set may contain genes that are changed in response to a stimulus, without an indication of the direction (up or down) of that change. The non-directional feature set may contain only up-regulated features, only down-regulated features, or both up and down-regulated features, but without indication of the direction of the change, so that all features are considered based on the magnitude of change only.

Gene-centric feature set—These are data sets in which the features are genes or proteins, e.g., as generated from platforms such as gene expression microarrays and proteomics platforms.

Sequence-centric feature set—These data sets include genomic sequence information and typically associated statistics and/or non-numerical information. Two main categories of features in sequence-centric feature sets are sequence or genomic regions and SNPs. SNPs may be thought of as a special case of a sequence region. Certain sequence-centric feature sets may contain information about the genetic profile or other molecular profiling data from an individual's sample (either genome wide or targeted). Unlike other feature sets, these “individual” feature sets often do not contain statistical information associated with the features but allele calls (sequencing for the sample). In certain embodiments, features in these individual features sets are not ranked and these individual feature sets are not correlated with all other feature sets during pre-processing. Certain feature sets contain aggregate data from multiple patient samples or other data sources such as plants, etc.

Patient-centric feature set—These are data sets associated with a particular patient. A patient-centric feature set can be derived from sequencing, microarray, or other molecular profiling technology. Each patient may have one or multiple samples (e.g., blood, lung tumor tissue, adjacent lung normal tissue), which were analyzed using molecular profiling technology. In addition, multiple types of molecular profiles can be present for each sample. A patient-centric feature set can include features and ranks, as well as associated clinical information. Associated clinical information can be in the form of tags and include information about the patient (e.g., gender, age, race, smoking status etc.), information about the assay (e.g., tissue), and other clinical attributes including but not limited to disease, duration of condition, etc.

Feature group—This refers to a group of features (e.g., genes) related to one another. As an example, the members of a feature group may all belong to the same protein pathway in a particular cell or they may share a common function or a common structural feature. A feature group may also group compounds based on their mechanism of action or their structural/binding features.

Index set—The index set is a set in the knowledge base that contains feature identifiers and mapping identifiers and is used to map all features of the feature sets imported to feature sets and feature groups already in the knowledge base. For example, the index set may contain several million feature identifiers pointing to several hundred thousand mapping identifiers. Each mapping identifier (in some instances, also referred to as an address) represents a unique feature, e.g., a unique gene in the mouse genome. In certain embodiments, the index set may contain diverse types of feature identifiers (e.g., genes, genetic regions, etc.), each having a pointer to a unique identifier or address. The index set may be added to or changed as new knowledge is acquired.

Knowledge base—This refers to a collection of data used to analyze and respond to queries. In certain embodiments, it includes one or more feature sets, feature groups, and metadata for organizing the feature sets in a particular hierarchy or directory (e.g., a hierarchy of studies and projects). In addition, a knowledge base may include information correlating feature sets to one another and to feature groups, a list of globally unique terms or identifiers for genes or other features, such as lists of features measured on different platforms (e.g., Affymetrix human HG_U133A chip), total number of features in different organisms, their corresponding transcripts, protein products and their relationships. A knowledge base typically also contains a taxonomy that contains a list of all tags (keywords) for different tissues, disease states, compound types, phenotypes, cells, as well as their relationships. For example, taxonomy defines relationships between cancer and liver cancer, and also contains keywords associated with each of these groups (e.g., a keyword “neoplasm” has the same meaning as “cancer”). Typically, though not necessarily, at least some of the data in the knowledge base is organized in a database.

Curation—Curation is the process of converting raw data to one or more feature sets (or feature groups). In some cases, it greatly reduces the amount of data contained in the raw data from an experiment. It removes the data for features that do not have significance. In certain embodiments, this means that features that do not increase or decrease significantly in expression between the control and test experiments are not included in the feature sets. The process of curation identifies such features and removes them from the raw data. The curation process also identifies relevant clinical questions in the raw data that are used to define feature sets. Curation also provides the feature set in an appropriate standardized format for use in the knowledge base.

Data import—Data import is the process of bringing feature sets and feature groups into a knowledge base or other repository in the system, and is an important operation in building a knowledge base. A user interface may facilitate data input by allowing the user to specify the experiment, its association with a particular study and/or project, and an experimental platform (e.g., an Affymetrix gene chip), and to identify key concepts with which to tag the data. In certain embodiments, data import also includes automated operations of tagging data, as well as mapping the imported data to data already in the system. Subsequent “preprocessing” (after the import) correlates the imported data (e.g., imported feature sets and/or feature groups) to other feature sets and feature groups.

Preprocessing—Preprocessing involves manipulating the feature sets to identify and store statistical relationships between pairs of feature sets in a knowledge base. Preprocessing may also involve identifying and storing statistical relationships between feature sets and feature groups in the knowledge base. In certain embodiments, preprocessing involves correlating a newly imported feature set against other feature sets and against feature groups in the knowledge base. The statistical relationships may be pre-computed and stored for all pairs of different feature sets having associated statistics and all combinations of feature sets having associated statistics and feature groups, although the invention is not limited to this level of complete correlation.

In one embodiment, the statistical correlations are made by using rank-based enrichment statistics. For example, a rank-based iterative algorithm that employs an exact test is used in certain embodiments, although other types of relationships may be employed, such as the magnitude of overlap between feature sets. Other correlation methods known in the art may also be used.

As an example, a new feature set input into the knowledge base is correlated with every other (or at least many) feature sets already in the knowledge base. The correlation compares the new feature set and the feature set under consideration on a feature-by-feature basis by comparing the rank or other information about matching genes. A rank-based iterative algorithm is used in one embodiment to correlate the feature sets. The result of correlating two feature sets is a “score.” Scores are stored in the knowledge base and used in responding to queries.

Study/Project/Library—This is a hierarchy of data containers (like a directory) that may be employed in certain embodiments. A study may include one or more feature sets obtained in a focused set of experiments (e.g., experiments related to a particular cardiovascular target). A Project includes one or more Studies (e.g., the entire cardiovascular effort within a company). The library is a collection of all projects in a knowledge base. The end user has flexibility in defining the boundaries between the various levels of the hierarchy.

Tag—A tag associates descriptive information about a feature set with the feature set. This allows for the feature set to be identified as a result when a query specifies or implicates a particular tag. Often clinical parameters are used as tags. Examples of tag categories include tumor stage, patient age, sample phenotypic characteristics and tissue types. Tags may also be referred to as concepts.

Mapping—Mapping takes a feature (e.g., a gene) in a feature set and maps it to a globally unique mapping identifier in the knowledge base. For example, two sets of experimental data used to create two different feature sets may use different names for the same gene. Often the knowledge base includes an encompassing list of globally unique mapping identifiers in an index set. Mapping uses the knowledge base's globally unique mapping identifier for the feature to establish a connection between the different feature names or IDs. In certain embodiments, a feature may be mapped to a plurality of globally unique mapping identifiers. In an example, a gene may also be mapped to a globally unique mapping identifier for a particular genetic region. Mapping allows diverse types of information (i.e., different features, from different platforms, data types and organisms) to be associated with each other. There are many ways to map and some of these will be elaborated on below. One involves the search of synonyms of the globally unique names of the genes. Another involves a spatial overlap of the gene sequence. For example, the genomic or chromosomal coordinate of the feature in a feature set may overlap the coordinates of a mapped feature in an index set of the knowledge base. Another type of mapping involves indirect mapping of a gene in the feature set to the gene in the index set. For example, the gene in an experiment may overlap in coordinates with a regulatory sequence in the knowledge base. That regulatory sequence in turn regulates a particular gene. Therefore, by indirect mapping, the experimental sequence is indirectly mapped to that gene in the knowledge base. Yet another form of indirect mapping involves determining the proximity of a gene in the index set to an experimental gene under consideration in the feature set. For example, the experimental feature coordinates may be within 100 base pairs of a knowledge base gene and thereby be mapped to that gene.

Correlation—Information integrated into a knowledge base can be correlated with existing information in the knowledge base, including feature sets, feature groups, concepts and patients.

As an example, a new feature set input into the knowledge base is correlated with every other (or at least many) feature sets already in the knowledge base. The correlation compares the new feature set and the feature set under consideration on a feature-by-feature basis comparing the rank or other information about matching genes. A ranked based running algorithm is used in one embodiment (to correlate the feature sets). The result of correlating two feature sets is a “score.” Scores are stored in the knowledge base and used in responding to queries about genes, clinical parameters, drug treatments, etc.

Correlation is also employed to correlate new feature sets against feature groups in the knowledge base. For example, a feature group representing “growth” genes may be correlated to a feature set representing a drug response, which in turn allows correlation between the drug effect and growth genes to be made.

2. Integrating Patient-Centric Information into a Knowledge Base

Aspects of the present invention relate to integrating patient-centric data into a knowledge base—a database of diverse types of biological, chemical and/or medical information. The following description presents one process by which knowledge base according to the present invention may be obtained. The knowledge base may contain feature sets based on raw data taken from large number of patients. Patient-centric feature sets can be obtained from public or private resources, from particular hospitals, research groups or clinical settings.

The knowledge base can also contain feature sets and feature groups from a number of sources, including data from external sources, such as public databases, including the National Center for Biotechnology Information (NCBI). The knowledge base can also include proprietary data obtained and processed by the database developer or user. A knowledge base may be continuously updated with new patient information or new information from other sources.

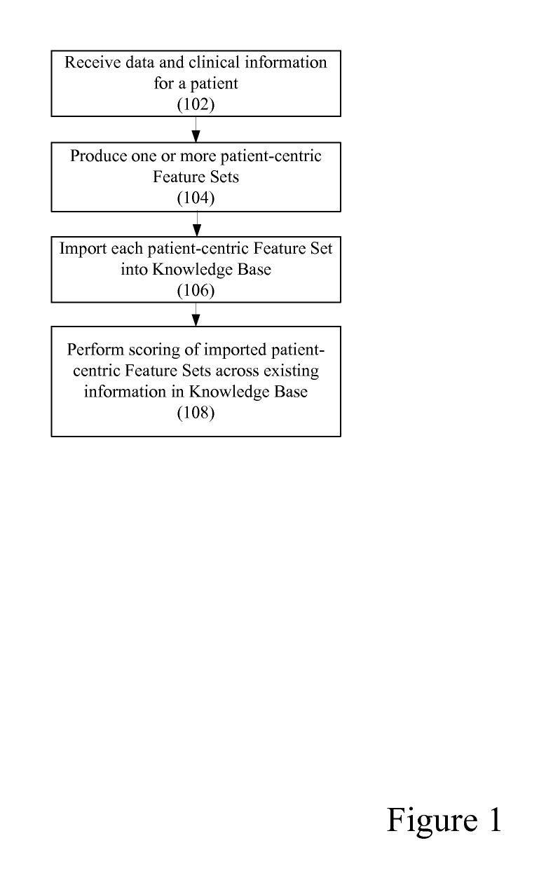

FIG. 1 shows an overview of the process of integrating patient-centric information into a knowledge base according to various embodiments. The process begins receiving patient data and associated clinical information. Block 102. As described above, a patient may have one or multiple samples (e.g. blood, lung tumor tissue, adjacent lung normal tissue), which can be analyzed using molecular profiling technology. One or more types of molecular profiles or other assays can be present for each sample. In certain cases, the patient data as received is in condition to be imported into the knowledge base as a feature set. In other embodiments, once the patient data is received, it is curated to produce one or more patient-centric feature sets. Block 104. Block 104 can involve re-organizing the patient data, removing less relevant information, annotating the data with attributes, etc. Additional information related to curating can be found in US Patent Publication 20070162411, titled “System And Method For Scientific Information Knowledge Management” incorporated by reference herein.

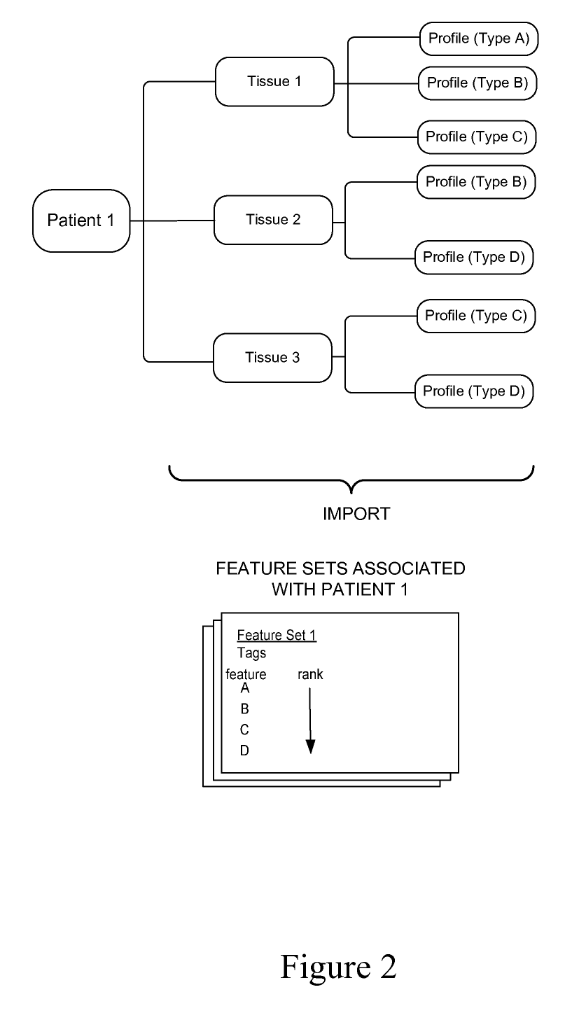

Feature sets are generated from a particular study or experiment and are imported into the knowledge base. Block 106. FIG. 2 provides a schematic depiction of seven different molecular profiles associated with a patient (Patient 1), three profiles associated with tissue 1, two with tissue 2, and two with tissue 3. These result in seven feature sets, one for each profile, imported into the knowledge base. As described below, importing the data can involve tagging the feature set with appropriate biomedical or chemical terms or concepts, as well as automatically mapping each feature in a feature set, i.e., establishing connections between each imported feature and other appropriate features in the knowledge base as appropriate. All molecular profile or other clinical assay information associated with a particular patient can be imported into the knowledge base.

Returning to FIG. 1, imported patient-centric feature sets are scored across existing information in the knowledge base. As described further below, this can include scoring the imported feature sets against other feature sets, feature groups and concepts in the knowledge base. In addition, it can include correlating the patient across all patients within the knowledge base. This can enable identification of similar patients. There are numerous applications of this scoring framework with scientific and social implications. For example, identifying similar patients may help guide clinician's decision for a given patient's treatment. In a social context, patients with similar molecular profiles can be identified, connected, used to form a group that directs its members' treatment decisions or lifestyle choices.

### A. Importing Patient Data

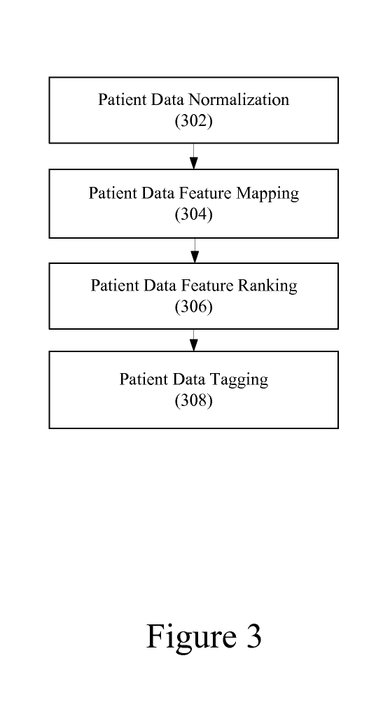

FIG. 3 shows an overview of the process of importing a patient-centric feature set into a knowledge base according to various embodiments. The process begins with data normalization. Block 302. Data normalization may be applied when the data in a feature set is unique to the particular patient. For example, when a patient's samples represent somatic tissues (e.g., diabetic pancreas biopsy, lung tumor tissue, etc.), normalization relative to normal tissue samples is obtained. This allows data across multiple patients to be compared later, for example, in preprocessing. Certain types of data may not need to be normalized

In some embodiments, data in a feature set (e.g., molecular profiling data in a given somatic tissue sample) is normalized relative to adjacent normal tissue, if available. In some embodiments, data in a feature set is normalized relative to a global tissue reference constructed from unrelated patient data. For example, when lung tumor that was analyzed using RNA expression profiling technology enters the system normalization will be performed relative to its adjacent normal tissue's RNA expression. If adjacent normal tissue is not available the system can apply its global normal lung reference database for normalization.

The patient's data is mapped to a standardized reference such as gene or SNP indexes, standard DNA coordinates and other relevant indexes. Block 304. Description of mapping features is given in US Patent Publication 20070162411, titled “System And Method For Scientific Information Knowledge Management.” Description of a mapping sequence-centric features is given in U.S. Patent Publication 2010/0318528, incorporated by reference herein. Features of each feature set associated with a given patient are mapped to a standard genomic (or other) reference, as well as to the features across all other patients.

The features in the feature set are then ranked. Block 306. Ranks provide some indication of the relative importance of each feature within the feature set. Ranking can based on one or more of the associated statistics in a feature set, for example features may be ranked in order of decreasing fold-change or increasing p-value. In certain embodiments, a user specifies what statistic is to be used to rank features.

In embodiments in which the features of a feature set are genome variants or mutations, a ranking may be obtained from predetermined ranks for variants/mutations that are based on the severity of a variant/mutation. In certain embodiments, the severity indicates the potential impact of the variant/mutation on a transcript/protein product. In some embodiments, a class and associated rank for every base in the human genome is pre-computed and a part of a knowledge base. In one example, a mutation classified as a stop codon mutation and assigned a relatively high rank, e.g., 1, indicating that it is a severe mutation. In another example, a mutation classified as an intergenic mutation is assigned a relatively low rank, e.g., 10, indicating that it is less severe.

Importing a feature set can also involve tagging the feature set. Block 308. Tagging can be done automatically and/or manually and can involve associating key concepts, including the patient's clinical information, with the feature set. Tags are standard terms that describe key concepts from biology, chemistry or medicine associated with a feature set, feature group, patient or other information in the knowledge base. Tagging allows users to transfer these associations and knowledge to the system along with the data. In some embodiments, tags include clinical attributes or annotations such as age, gender, race, tumor type, tumor stage, survival statistics, cholesterol level, erythrocyte sedimentation rate (ESR), etc. Standardized ontologies within the knowledge base are used. In some embodiments, tagging can involve using a binned concept for continuous clinical attributes such as age or survival duration. For example, a feature set of a 25 year old patient may be tagged with one or more of the following: 20-40 years old, 25-35 years old, etc.

Referring back to FIG. 2, once imported, the feature sets associated with a patient include a list of features and associate ranks, as well as a list of tags. In some embodiments, a feature set may also include statistical information associated with the features in addition to ranks.

### B. Scoring Patient Data

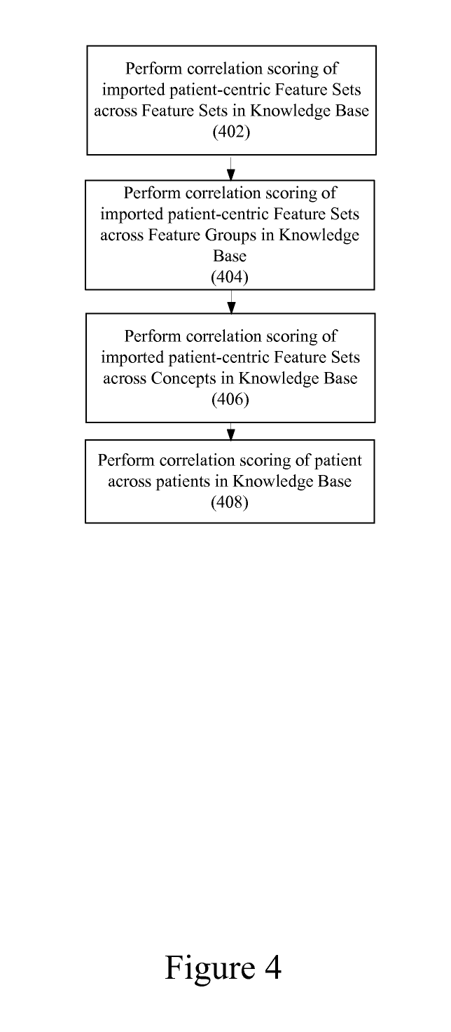

Patient data can be compared across information existing in the knowledge base. In some embodiments, a patient's data is compared to data associated with other patients across all patients within the system. The analysis can be done across different data types within the system. FIG. 4 shows an overview of certain operations in processes of scoring a patients' information with other information in the knowledge base. First, correlation scoring of imported patient-centric feature sets across existing feature sets in the knowledge base is performed. Block 402. According to various embodiments, each feature set associated with a patient can be compared to feature sets across all or a plurality of patients within the knowledge base. Feature sets associated with a patient can also be compared to non-patient-centric feature sets in the knowledge base. Correlation scoring between the imported patient-centric feature sets across feature groups within the knowledge base is performed. Block 404. According to various embodiments, each feature set associated with a patient can be compared to all or a plurality of feature groups within the knowledge base. In some embodiments, each feature set is compared with all or at least most of the feature sets and feature groups in the knowledge base. In some cases, correlations may not be performed, if for example, the correlation does not yield meaningful connections between data sets

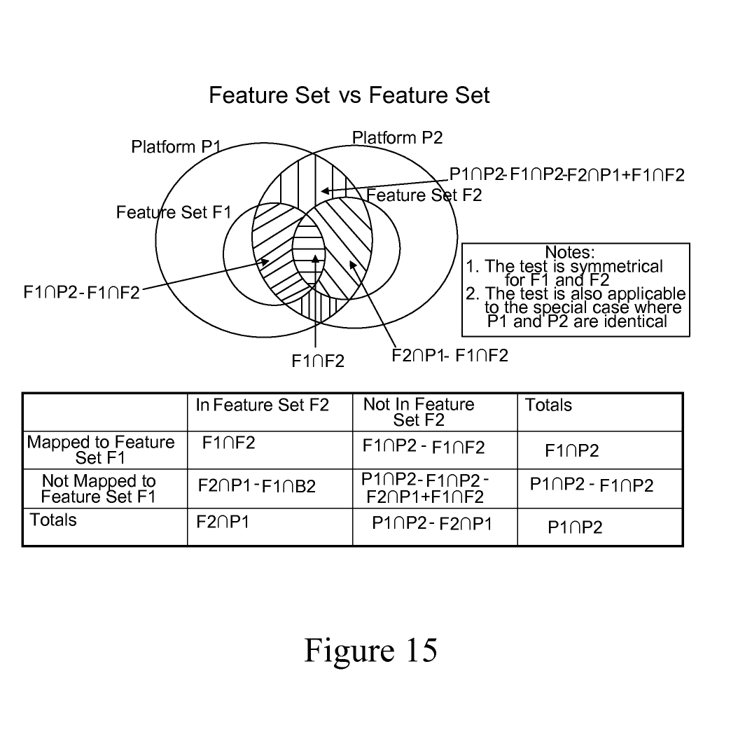

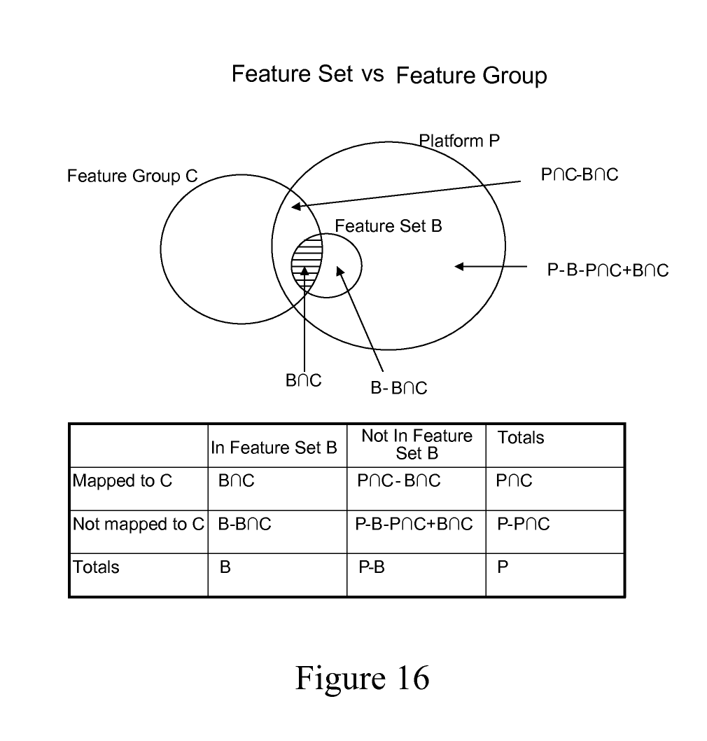

Correlation scoring between feature sets, and between feature sets and feature groups, is described in U.S. Patent Publications 2007/0162411, 2009/0049019, and 2010/0318528, incorporated by reference herein. U.S. Patent Publication 2007/0162411 titled “System And Method For Scientific Information Knowledge Management” describes feature set v. feature set correlation using a rank-based algorithm. The ranks determined in data import can be employed. U.S. Patent Publication No. 2009/0049019 titled “Directional Expression-Based Scientific Information Knowledge Management” describes directional correlation scoring, which takes into account the direction of the correlation between feature sets, i.e., whether the correlation is positive or negative. U.S. Patent Publication No. 2010/0318528 titled “Sequence-Centric Scientific Information Management” describes correlation scoring of sequence-centric feature sets. FIGS. 15 and 16 provide set diagram showing an example of a Feature Set versus Feature Set relationship and Feature Set versus Feature Group relationships that may be used to determine correlations in certain embodiments.

The process described in FIG. 4 can also include categorization and correlation scoring between the imported patient-centric feature sets and concepts in the knowledge base. (Block 406). Concept scoring is described in U.S. Patent Publication 2009/0222400, titled “Categorization And Filtering Of Scientific Data,” incorporated by reference herein. Concept scoring for sequence-centric feature sets is described in U.S. Patent Publication No. 2010/0318528, referenced above.

The process described in FIG. 4 can also include performing correlation scoring of patients across all or a subset of patients in the knowledge base. (Block 408). As indicated above, there may be multiple feature sets for a particular patient. In some embodiments, block 408 can involve comparing feature sets of like data types between patients. For example, if patient P1 has three feature sets, of data types 1, 2 and 3, respectively and patient P2 has two feature sets of data types 1 and 3, respectively, obtaining a correlation between patient P1 and patient P2 can involve correlation the feature sets of data type 1 and/or correlating the feature sets of data type 3. In some embodiments, obtaining a score P1-P2 indicating a correlation between patient 1 and patient 2 can involve taking an average of, or otherwise aggregating, the feature set correlations. In some embodiments, obtaining a score P1-P2 indicating a correlation between patient 1 and patient 2 can involve taking the feature set correlation score that indicates the highest correlation. In some embodiments, a global comparison of patient P1 across all patients in the knowledge base can be performed. In some other embodiments, a comparison can be made across only a subset of patients. For example, if a patient has lung cancer or other status, patient-patient pairwise scores may be found across patients that have lung cancer.

### 3. Knowledge Base

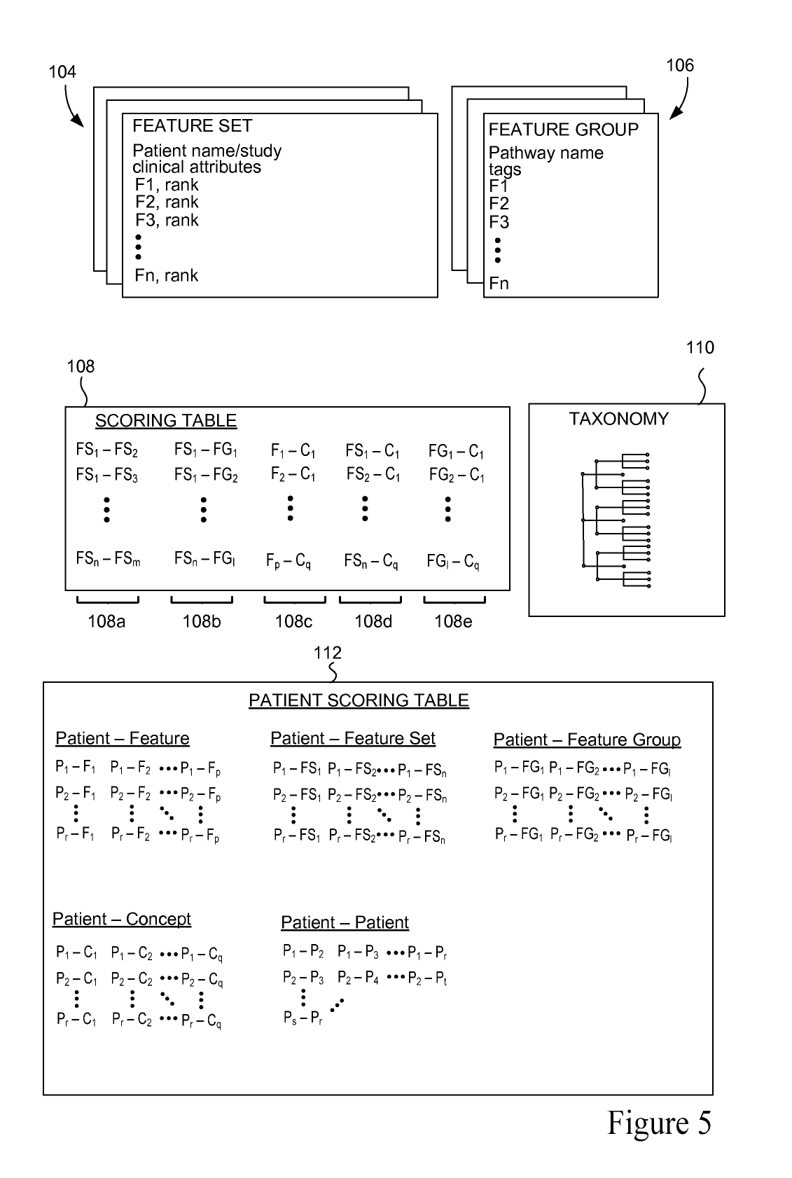

FIG. 5 shows a representation of various elements in a knowledge base including patient information. Examples of generation of or addition to some of these elements (e.g., feature sets and a feature set scoring table) are discussed above and in U.S. Patent Publications 2007/0162411, 2009/0049019, 2010/0318528, and 2010/0318528. In FIG. 5, element 104 indicates all the feature sets in the knowledge base. Element 104 shows a feature set including a patient name (or other identifier). The feature set also includes a list of clinical attributes as described above, and a list of features F1, F2, etc. with associated ranks. Features can be identified by an imported ID, a feature identifier, and/or a mapping identifier. Mapping identifiers and ranks may be determined during the import process, as described above. A feature set can also contains statistics associated with each feature, e.g., p-values and/or fold-changes. In addition to patient-centric feature sets, the knowledge base can include other types of feature sets including feature sets derived from public databases, experiments conducted by a researcher or other information.

Element 106 indicates all the feature groups in the knowledge base. Feature groups can contain a feature group name, and a list of features (e.g., genes) related to one another. A feature group can represent a well-defined set of features generally from public resources—e.g., a canonical signaling pathway, a protein family, etc. Unlike feature sets, the feature groups do not typically have associated statistics or ranks. The feature sets may also contain an associated study name and/or a list of tags.

Element 110 represents one or more standardized taxonomies or ontologies that contains tags or scientific terms for different tissues, disease states, compound types, phenotypes, cells, clinical attributes and other standard biological, chemical or medical concepts as well as their relationships. The tags can be organized into a hierarchical structure as schematically shown in the figure. An example of such a structure is Diseases/Classes of Diseases/Specific Diseases in each Class. The knowledge base may also contain a list of all Feature Sets and Feature Groups associated with each tag. The tags and the categories and sub-categories in the hierarchical structure are arranged in what may be referred to as concepts. Clinical attributes as described above can be organized into one or more taxonomies.

Element 108 indicates a scoring table, which contains measures of correlation between datasets and concepts in the knowledge base. Examples of pairwise scores 108a-108e indicating correlations are given in FIG. 5: correlations between feature sets are indicated at 108a, correlations between feature sets and feature groups are indicated at 108b, correlations between features and concepts are indicated at 108c, correlations between feature sets and concepts are indicated at 108d and correlations between feature groups and concepts are indicated at 108e. As with the other elements represented in FIG. 5, the organizational structure of the scoring table is an example; other structures may also be used to store or present the scoring.) In the figure, FS₁-FS₂ is a measure of relevance of Feature Set 1 to Feature Set 2, FS₁-FG₁ is a measure of relevance of Feature Set 1 to Feature Group 1, F₁-C₁ is a measure of relevance of Concept 1 to Feature 1, FS₁-C₁ a measure of relevance to Concept 1 to Feature Set 1; and FG₁-C₁ a measure of relevance to Concept 1 to Feature Group 1, etc. In certain embodiments, a scoring table can include information about the relevance or correlation of at least some concepts with each of all or a plurality of other concepts.

Element 112 is a patient scoring table, including correlation information between individual patients (P1, P2, P3, etc.). (For the purposes of discussion, element 112 is shown in FIG. 5 as being an element separate from element 108; however the information contained in these elements may be stored in any appropriate structure.) Element 112 includes patient-feature pairwise scores (P₁-F₁), patient-feature set pairwise scores (P₁-FS₁), patient-feature group pairwise scores (P₁-FG₁), patient-concept pairwise scores (P₁-C₁) and patient-patient pairwise scores (P₁-P₂). Anyone or more of the categories of pairwise scores in elements 108 and 112 may not necessarily be pre-computed or present according to the desired embodiments. For example, patient-feature correlations may be calculated on the fly if needed during a query.

A knowledge base may also include other elements such as an index set, which is used to map features during a data import process. A knowledge base can also include a global tissue reference, which is a reference compiled from a large collection of normal tissue samples that can serve as reference to normalize data obtained from diseased tissues. A global tissue reference can include gene expression, DNA methylation or other relevant type of profile data for normal tissues. A global tissue reference can be assembled from publicly available and/or private data sources. A knowledge base can also include information such as mutation classification used to determine a rank of a variant upon import.

### 4. Patient-Germline DNA Analysis

One of the key applications of DNA sequencing is identifying mutations, DNA polymorphisms and structural variations in a germline or somatic DNA. Germline DNA analysis can reveal set of variants (such as mutations, polymorphisms and structural variations) that can increase patient's disease risk, toxic response to drug treatment and a plethora of other phenotypes and conditions. Identifying pathways impacted by genome variants can also reveal valuable information about risks of diseases or treatments with potential side effects. Identification of impacted tissues and associated variants can guide a researcher of physician about the conditions that may be associated with impacted tissue or organ.

The majority of variants in the human genome have unknown impacts. The germline DNA analysis can be used to identify mutations associated with a particular pathway, phenotype (e.g., diseases and conditions), and tissues.

Patient-germline DNA analysis can include one or more of: identifying impacted pathways and associated variants, identifying impacted phenotypes and associated variants and identifying impacted tissues and associated variants.

### A. Identifying Impacted Pathways and Associated Variants

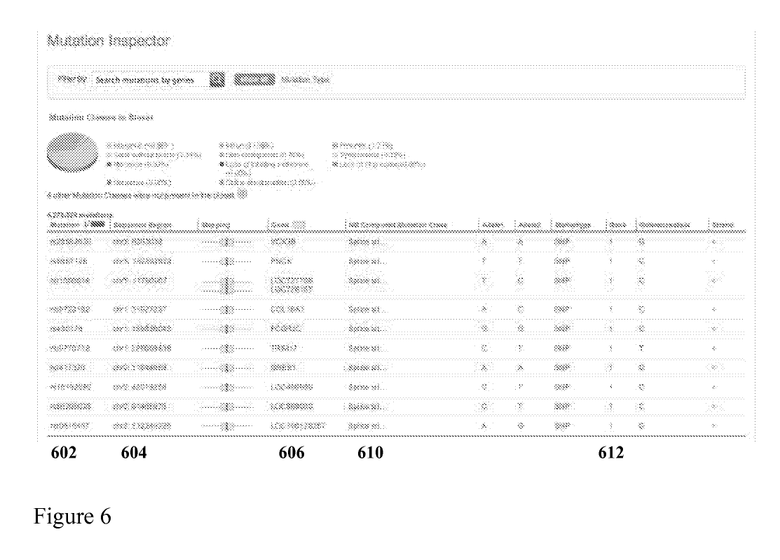

Variants in a patient's genome can be prioritized based on their severity class assigned during the data import. This severity class can be used to assign rank to each variant as described above with reference to block 306 of FIG. 3. FIG. 6 provides a screenshot showing different mutation classes and associated ranks for certain variants in a feature set. In this example, the feature set can be all variants in a patient's genome as determined on data import or as determined prior to import. Column 602 includes a list of features, in this case a list of mutations in a patient's genome. Column 604 indicates the sequence region the feature is found in, with column 606 indicating a gene that the feature is mapped to. Column 610 indicates the Computed Mutation Class, with column 612 indicating the rank assigned to the feature based on the computed mutation class. FIG. 6 shows only a subset of features within the feature set. Note that all of the variants in the feature set shown in FIG. 6 have the rank “1”; however, variants having lower ranks (indicating a less severe variant) can also be present. Once a feature set including ranked variants is defined, a feature group enrichment analysis can be applied.

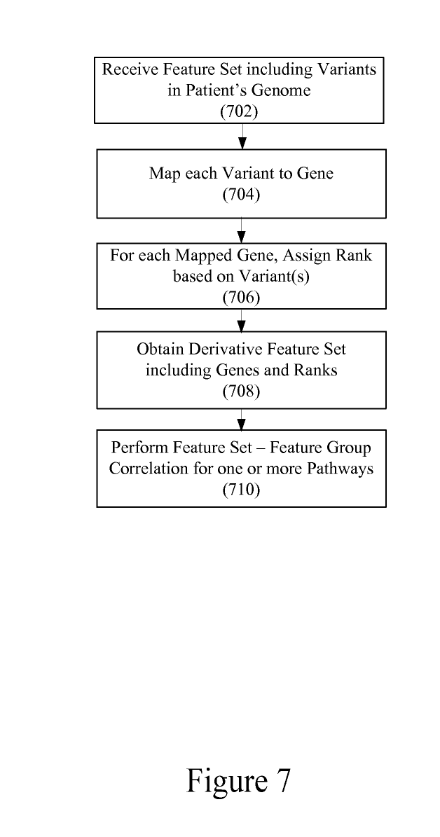

Once a feature set including ranked variants is defined, a feature group enrichment analysis is applied. Pathways represent a subset of feature groups, and thus can be assessed for significance of impact within a given patient's genome (ranked feature set). FIG. 7 shows an overview of a process of performing a feature group enrichment algorithm according to certain embodiments. A feature set with variants is received. Block 702. Each variant is mapped to a gene. Block 704. Blocks 702 and 704 may be performed as part of an import process, with examples of variants and mapped genes for a feature set shown above in FIG. 6. For each mapped gene, a rank is assigned based on the variants to which the gene is mapped. Block 706. Typically, the gene can inherit the ranking of the associated variant. For example, if variant V₁ has a rank of 2 (based on its disruptive potential) and is mapped to gene G₄, then gene G₄ can be assigned a rank of 2. In certain cases, multiple variants are mapped to a single gene. In these cases, block 706 can involve identifying the highest rank and assigning that rank to the mapped gene. For example, if variant V₁ with a rank of 2, variant V₂ with a rank of 1, and variant V₃ with a rank of 2, are assigned to gene G₂, G₂ can be assigned a rank of 1. Other methods of assigning ranks to genes based on the severity of the mapped variants can also be used. In some cases, for example, the number of variants that are mapped to a gene may be taken into account in block 706. A derivative gene-centric feature set, including mapped genes and the ranks assigned in block 706, is then obtained. Block 708. Blocks 702-706 can be performed on data import or in response to instructions or a query by a user. Feature set to feature group correlation can then be performed by a running Fisher algorithm as described above. Block 710. In one example, the feature set represents all variants in a patient's genome, with the feature group(s) being a biological pathway. Block 710 can be performed for all feature groups representing biological pathways. In this manner, pathways that are enriched, or significantly correlated to the patient's genome, can be identified.

### B. Identifying Impacted Phenotypes and Associated Variants

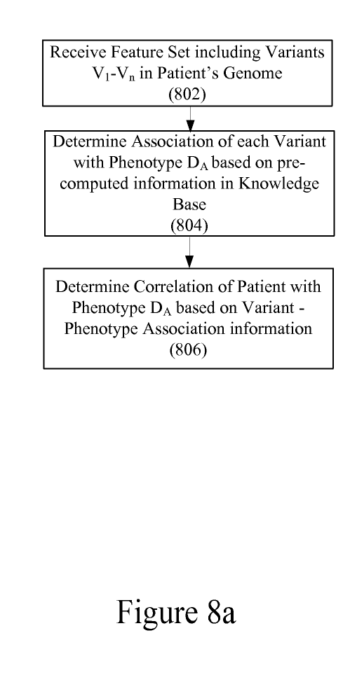

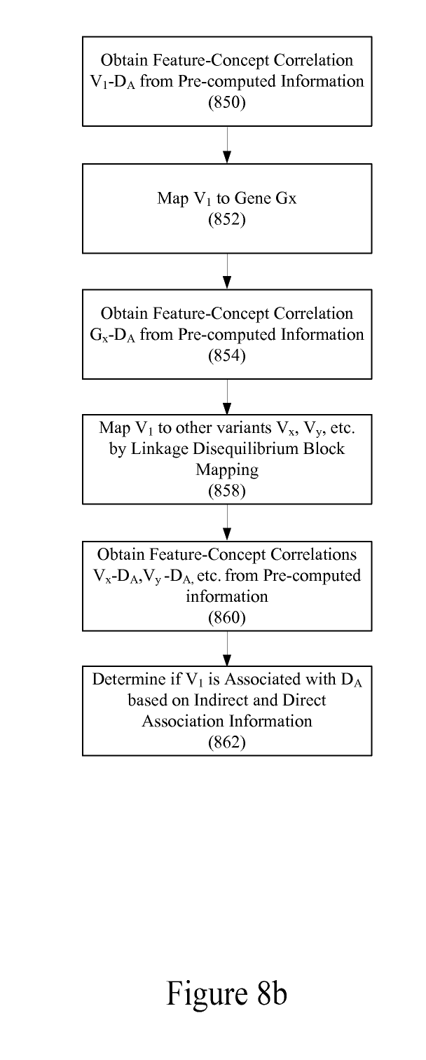

Methods and apparatus for identifying impacted phenotypes and associated variants can be provided. FIG. 8a shows an overview of a process of identifying impacted phenotypes based on a patient's variants according to certain embodiments. First, a feature set including variants in a patient's genome is received. Block 802. In an example, a feature set may include variants V₁-Vₙ, which can represent all or a subset of variants in a patient's genome. The association of each variant V₁-Vₙ with a phenotype D_{A} is then determined based on information in the knowledge base. Block 804. The phenotype D_{A} can be a disease (e.g., heart disease), condition (e.g., high cholesterol), or other phenotype. Block 804 can involve identifying if each variant V₁-Vₙ is associated with D_{A} based on one or multiple criteria in some embodiments, including if there is an association in the knowledge base between the variant in question and the phenotype, if the variant is mapped to a gene that is associated with the phenotype, and if the variant is associated with another variant that is associated with the phenotype. FIG. 8b shows an example of determining an association between a variant V₁ and a phenotype D_{A} based on multiple criteria. The process in FIG. 8b starts by obtaining feature-concept correlation from pre-computed information, with the feature being variant V₁ and the concept being phenotype D_{A}. (Block 850). In some embodiments, this can involve obtaining a correlation score V₁-D_{A} from a concept scoring table as schematically depicted at 108c in FIG. 5. In some cases, there may be no correlation score V₁-D_{A} or the value may be returned as null. The variant V₁ is mapped to gene Gₓ. (Block 852). While presented in the process flow of FIG. 8b, block 852 may be performed earlier during mapping. See, e.g., FIG. 6, which shows variants and mapped genes generated during a mapping process. The process continues by obtaining feature-concept correlation from pre-computed information with the feature being gene Gx and the concept being phenotype D_{A} (Block 854). In some embodiments, this can involve obtaining a correlation score Gₓ-D_{A} from a feature-concept scoring table as schematically depicted at 108c in FIG. 5. In some cases, there may be no correlation score V₁-D_{A} or the value may be returned as null. The process can continue by mapping V₁ to other variants Vₓ, V_{y}, etc. by linkage disequilibrium block mapping. (858). Block 858 also may be performed earlier in a mapping process. The process continues by obtaining feature-concept correlations from pre-computed information with the feature being each feature Vₓ, V_{y}, etc. and the concept being phenotype D_{A}. (Block 860). In some embodiments, this can involve obtaining correlation scores Vₓ-D_{A}, etc. from a feature-concept scoring table as schematically depicted at 108c in FIG. 5. Based on the direct association information (block 850) and indirect association information (blocks 854 and 860), it is determined if the variant is associated with the phenotype D_{A}. (Block 862). Block 862 can involve determining a binary yes-no determination, or can involve assigning V₁-D_{A} a score indicating the strength of correlation based on different criteria. In some embodiments, block 862 can involve a separate determination for the direct and indirect association information, in addition to or instead of combining the information derived from indirect and direct association. For example, if a physician elects to see correlation information based only on information having a high confidence threshold, the system may determine a patient-phenotype correlation based only on direct associations.

Returning to FIG. 8a, based on the associations of each variant in a patient's genome with the phenotype D_{A}, the correlation between the patient and the phenotype D_{A} can be determined. Block 806 can involve, for example, using the number of variants associated with the phenotype D_{A} out of the total number of variants associated with phenotype D_{A}. For example, for a patient P₁ and phenotype D_{A}, a correlation, P₁var-D_{A}, indicating the impact of the variants of patient P₁ on the phenotype D_{A} can be:

P₁var-D_{A}=Number of variants in P₁-var feature set associated with D_{A}/Total variants associated with D_{A} (Equation 1)

Equation 1 is an example of one way in which pre-existing information in the knowledge base can be used to determine the impact of a patient's germline DNA can be used to identify impacted phenotypes. In other examples, the variants may be weighted based on the strength of the association with the variants with the phenotype, as determined from the concept analysis described above, and/or the type of the variant classification described above.

The correlation of a patient's genome with phenotypes can be determined for every disease or condition in the knowledge base. In this manner, the germline DNA analysis can be used to assess a predisposition of a normal patient for a particular disorder or other phenotype and identify the variants that are associated with the disorder. Identifying the variants can include identifying which variants are severe. The germline DNA analysis can be used to compute risk of a patient developing a condition such as arthritis, heart disease, etc. In addition, the germline DNA analysis can be used to direct diagnosis. For example, a physician diagnosing a patient's hearing loss can submit the patient's sequencing data to the system, which can return a list of variants in the patient's genome that are related to hearing loss, and hearing loss-related conditions that are associated with those variants, as derived from the germline analysis described above.

### C. Identifying Impacted Tissues and Associated Variants

Methods and apparatus for identifying impacted tissues and associated variants can be provided. This can involves the identification and ranking of variants that may have an impact on a tissue/organ in a given patient. In addition, it allows assessment of tissues or organs that may be most significantly impacted by genome variants.

In some embodiments, the analysis involves identifying tissue-specific genes based on the large collection of gene expression data from diverse organs and tissues in the knowledge base. In some embodiments, the method uses pre-computed tissue-specific features sets. Tissue-specific feature sets are feature sets generated from multi-tissue experiments and contain features that show specificity for a particular tissue or tissues. An example of a tissue-specific feature set is liver-specific up-regulated genes. In some embodiments, the knowledge base contains one tissue-specific feature set for every tissue of interest. The tissue-specific feature sets can include up-regulated genes specific to the tissue. Generation of tissue-specific feature sets is discussed in U.S. Patent Publication 2007/0162411, referenced above.

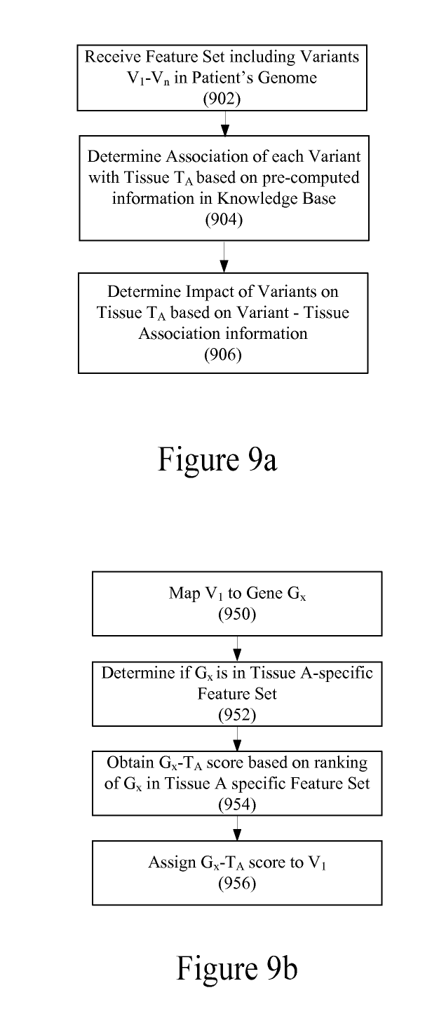

FIG. 9a shows an overview of an example of a process to identify impacted tissues based on a variants in a patient's genome. First, a feature set including variants in a patient's genome is received. Block 902. In an example, a feature set may include variants V₁-Vₙ, which can represent all or a subset of variants in a patient's genome. The association of each variant V₁-Vₙ with a tissue T_{A} is then determined based on information in the knowledge base. Block 904. FIG. 9b shows an example of determining an association of variant V₁ with tissue T_{A}. First, the variant V₁ is mapped to gene Gₓ. Block 950. As described above, this mapping may be done automatically during mapping during data import. Next, it is determined if gene Gₓ is specific to tissue T_{A}. In the example of FIG. 9b, this is done by checking if Gₓ is in the tissue A-specific feature set in the knowledge base. Block 952. For example, if tissue A is liver, the system may look at a tissue-specific feature set containing liver-specific up-regulated genes. If Gₓ is not present in the tissue-A specific feature set, it may be determined that the variant Vₓ does not impact the tissue T_{A}. If Gₓ is present in the tissue-A specific feature set, a score Gₓ-T_{A} may be determined based on the rank of Gₓ in the tissue-A specific feature set. Block 954. This score can then be assigned to the variant V₁ as an indication of the impact the variant can have on the tissue T_{A}. Block 956. Returning to FIG. 9a, the impact of the variants V₁-Vₙ on the tissue T_{A} is determined based on the variant-tissue association information. Block 906. One example of determining the impact of the variants on tissue A is given in the following equation:

P₁var-T_{A}=Sum(G-T_{A})_{VI-Vn}/Sum(G-T_{A})_{all tissue-A genes} (Equation 2)

P₁var-T_{A} is a score providing an indication of the impact of variants V₁-Vₙ in the patient's genome on tissue A. In Equation 2, it is calculated by summing the scores G-T_{A} (as determined for example in FIG. 9b) over all variants V₁-Vₙ and dividing against a background score of all genes in the tissue A-specific feature set. The individual scores can be weighted by the severity of the mutation as determined upon import. In some embodiments, the impact can be determined by a count of mutations that have significant impact on tissue-specific genes is applied.

An output of the analysis can also indicate the following:
Total number of tissue-specific genes for a given organ/tissue
Total number of tissue-specific genes impacted by person's genome variants for a given organ/tissue
Total number of impactful genome variants associated with a given organ/tissue

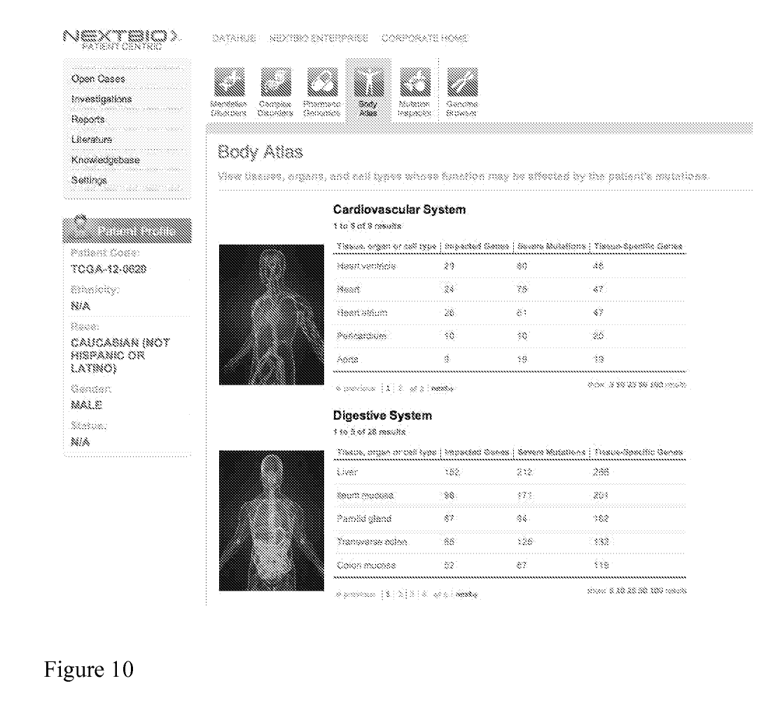

FIG. 10 shows a screenshot showing an example output of impacted tissues based on the germline DNA analysis, including a list of tissues (heart ventricle, heart, heart atrium, etc.), impacted genes, severe mutations, and the total number of tissue-specific genes for the tissue. For example, FIG. 10 shows that there are a total of 48 genes specific to the heart ventricle, with 29 of these 48 genes impacted in the patient by 80 severe mutations (variants). Note that in this case, at least some of the 29 impacted genes have multiple severe variants. Mutation severity can be determined as described above during import using pre-determined mutations classifications. Selecting a specific tissue will enable users to see the actual list of variants.

### 5. Patient-Somatic Tissue Analysis

In some embodiments, patient-somatic tissue analysis is provided.

### A. Identifying Impacted Pathways

Identification of impacted pathways based on genome variants identified in a somatic tissue, such as tumor, can follow the same logic as outlined above for germline DNA analysis. Ranked variants representing a feature set are scored against a set of all known pathways (feature set vs. feature group scoring), resulting in a set of pathways and associated enrichment p-values.

For RNA, DNA methylation and other molecular profiling data (e.g., proteomics) associated with a patient pathway impact can also computed using feature set vs. feature group analysis. As the final result, for a given patient the system can computes independent scores for each pathway relative to each available molecular profile (feature set):

Pathway score based on genome variants

Pathway score based on RNA expression

Pathway score based on miRNA expression

Pathway score based on DNA methylation

For example, a pathway score based on RNA expression for a particular patient can be derived by scoring a RNA expression feature set for the patient with a feature group representing a particular pathway. The score can be indicated as P₁RNA-FG and be determined using feature set v. feature group scoring as described above.

### B. Identifying Impacted Pathways Based on Combined Data Types

In some embodiments, a score indicating the impact for a pathway of interest within a somatic tissue of a given patient is derived from multiple data types. For example, in some embodiments, an average score based on multiple data types is determined: Patient-Pathway A Score=avg(P₁RNA-FG_{A}, P₁miRNA-FG_{A}, P₁var-FG_{A}, P₁meth-FG_{A}), with P₁RNA representing a feature set including patient P₁'s RNA expression data. Other methods of aggregating the individual pathway scores may also be applied.

### 6. Patient-Pathway-Based Therapy Selection

In some embodiments, methods of targeting treatment decisions for patient's subsequent treatment based on molecular profiling are provided. This is especially relevant to treating cancer patients where a number of personalized drugs are in development. However, this logic can be applied to other types of disorders. In some embodiments, the methods are based on the fact that a number of drugs target either a specific pathway or set of pathways. By identifying pathways most impacted in a given patient's disease tissue of interest the best possible drug or combination of drugs to prescribe to counteract effects of the disease can be predicted. In certain embodiments, the methods identify pathways targeted by a drug, as well as determining which pathways are impacted in a given patient.

### A. Identifying Pathways Targeted by a Treatment

Identification of pathways impacted by a particular treatment involves a number of different criteria. Manual curation of public databases and articles can be used to identify a set of pathways targeted by a given drug. In addition, categorization can be applied to identify top pathways targeted by a drug. Concept scoring described in U.S. Patent Publication 2009/0222400, referenced above, can used for concepts such drugs, diseases, and tissue. The output of a concept query can include: 1) a list of ranked features most significantly associated with a concept based on plurality of concept tagged feature sets; and 2) a list of ranked feature groups most significantly associated with a concept based on plurality of concept tagged feature sets. Identified feature groups (including pathways) associated with a concept (in this case a drug or other treatment) can be used to further expand the knowledge of pathways targeted by a given treatment. Subsequently, this information can be used to link a drug to pathways most impacted in a given patient.

In some embodiments, curated knowledge in the knowledge base includes known treatment—pathways associations, e.g., available from publicly available sources. As described above in Sections 3 and 4, impacted pathways of a patient's molecular profiling information can be determined. Accordingly, for a particular treatment and patient, a score can be returned based on the patient—pathway information.

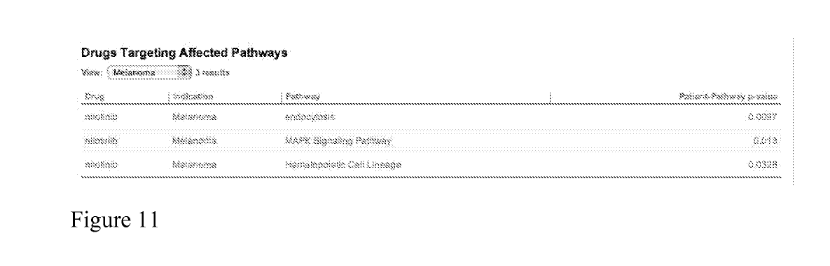

For example, Drug A may be associated with feature groups FG_{A,} FG_{B,} and FG_{C}, each of which represents a pathway. A patient-pathway score or p-value can be returned for each pathway. FIG. 11 shows an example patient report based on genome variants from a patient's melanoma tumor. “Drugs targeting affected pathways” lists drugs that target the same pathways as the ones impacted in that patient. Associated p-value indicates the significance of impact of a given pathway in a patient.

As described above, in addition to or instead of using curated knowledge, concept scoring can be used to identify pathways. Here, a correlation score between a pathway and a treatment can be obtained from a concept scoring table. For example, a score FG₁-C₁ for a pathway represented by feature group FG₁ and a treatment C₁ can be obtained from a table such as that indicated at 108e in FIG. 5. As described above in Sections 3 and 4, an impact of a patient's molecular profiling on the pathway FG₁ can also be obtained. These two scores can then be aggregated to provide an indication of the treatment (C₁) with the patient. For example, a score for a drug can be given by adding, multiplying, or otherwise combining these scores.

B. Prioritizing Drugs Matching a given Patient

Identifying the most impactful pathways for a given patient is described above in Sections 3 and 4, and associating a drug with its target pathway(s) is described above in Section 5A. Prioritizing drugs or other treatments for a given patient can then involve a lookup of drugs that target pathways most impacted in a given patient. This lookup can involve additional computations (for example if a computed drug-pathway associated contains a score, and patient's pathway impact contains a score—these scores can be combined into one). In addition, in some cases drugs that are designed to treat patient's disorder already may be given a higher priority. In other cases, off-label drugs (designed for other types of disorders) may be chosen.

### 7. Queries

The above description of methods, computational systems, and user interfaces for creating and defining a knowledge base provides a frame work for describing a querying methodology that may be employed with the present invention. The querying methodology described herein is not however limited to the specific architecture or content of the knowledge base presented above. Generally, a query involves (i) designating specific content that is to be compared and/or analyzed against (ii) other content in a “field of search” to generate (iii) a query result in which content from the field of search is selected and/or ranked based upon the comparison. As examples, a user may query a feature (e.g., a gene, SNP or sequence region), a feature group (e.g., a pathway), a patient's feature set (patient's molecular data, such as genes, SNPs, sequence regions and associated statistical values) and a (e.g., drug). A query may be limited to a particular field of search within the knowledge base. The search may include the entire knowledge base and this may be the default case. The user may define a field of search or the system may define it automatically. Feature set vs. feature set and feature set vs. feature group queries typically rely on pre-computations of correlation scores. Concept queries may also rely on pre-computations of concept scores.

The knowledge base includes patients, their associated molecular feature sets and clinical annotations (tags). A number of queries can be enabled to provide users insights about individual patients, molecular entities' association with clinical information (e.g. how a feature of interest is correlated with outcome of treatment by a particular drug). These queries involve meta-analysis across large collection of patients, as well as their associated clinical attributes (tags).

In addition, query criteria can be defined very specifically and refer to a particular type of data associated with patients in a knowledge base. For example, a user can define a query to:

Find all patients where a given gene is up/down regulated

Find all patients where a given gene/region is amplified/deleted

Find all patients where a given gene is methylated

Find all patients where a given gene is mutated

Find all patients with a given mutation/SNP

### A. Queries Returning List of Ranked Patients

Returning a ranked list of patients involves performing a query against feature sets. Queries against feature sets are described in U.S. Patent Publications 2007/0162411, 2009/0049019, 2009/0222400 and 2010/0318528, all of which are referenced above. These queries can returned a ranked list of feature sets, which in this case are a ranked list of patients. The associated score or rank of each patient, in return to a query, will depend on the query type. For example, queries based on a specific feature (e.g. a gene) the system will use gene's rank in each patient's feature set to rank the actual patients. For feature group queries the system can use precomputed scores between patient's feature set and query feature group. For queries based on specific patient, a feature set associated with that patient (since patients may have multiple feature sets associated with them user can select the one of interest) the system will return ranked list of patients based on precomputed pairwise correlation scores described above.

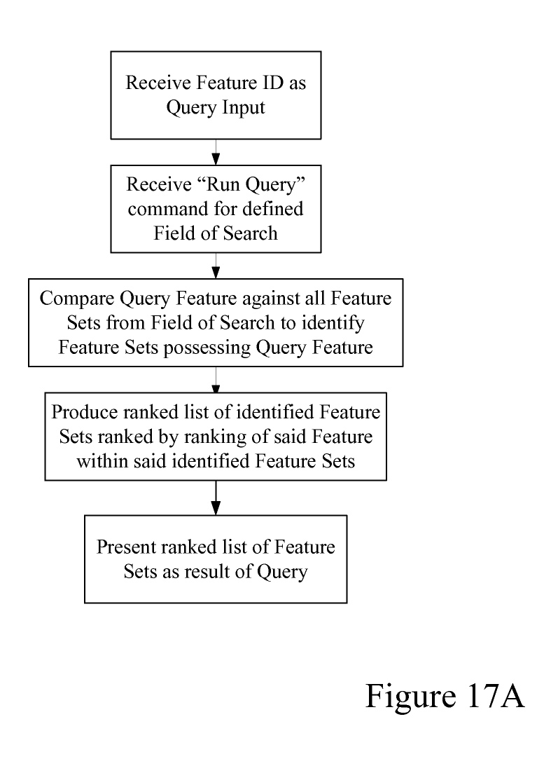

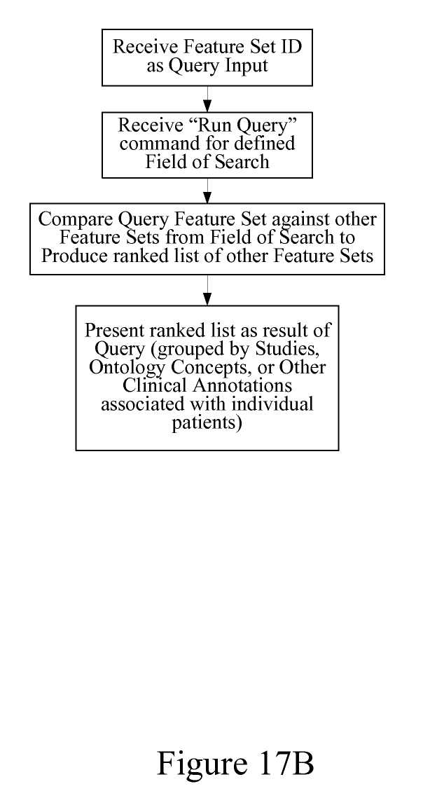

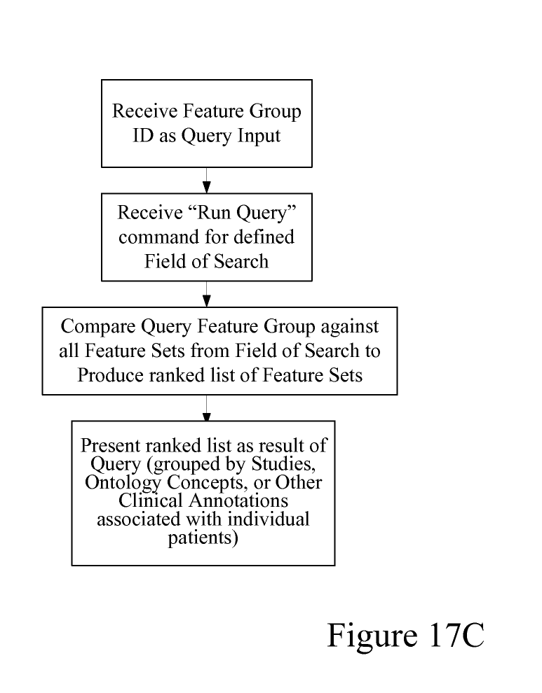

FIGS. 17A-17C provide overviews of process flows for returning ranked lists of feature sets (patients) in response to various queries.

### B. Queries Returning Set of Clinical Attributes and Attribute Values

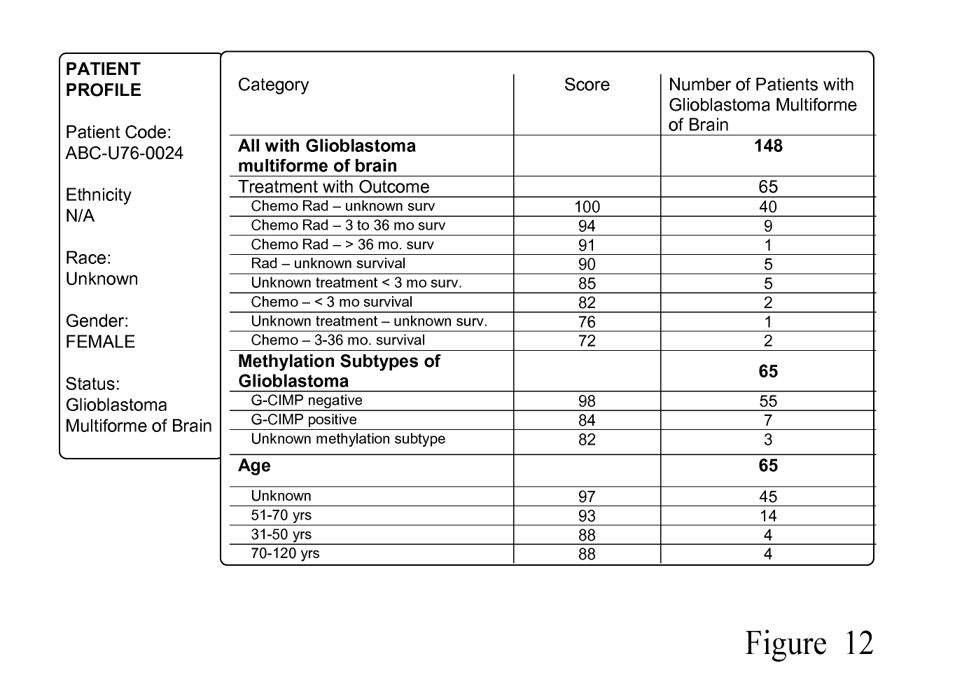

In addition to returning a list of ranked patients the system can also precompute for each query type categorization results based on clinical attributes associated with patients in a database. This will enable users to gain a high-level understanding of most significant clinical subgroups among the ranked list of patients. This can be useful, since a list of patients could contain hundreds of thousands, or even millions of patients. Understanding key clinical values associated with a query may be very useful to guide a user. Returning categorization results is described in U.S. Patent Publication 2009/0222400, referenced above. With patient-centric information, there is a potentially very large number of concepts. For example, there may be hundreds of thousands of clinical attributes. FIG. 12 shows an example of a ranked list of clinical attributes resulting from a query of a patient's somatic genome (feature set) against all patients having glioblastoma.

### 8. Apparatus

As should be apparent, certain embodiments of the invention employ processes acting under control of instructions and/or data stored in or transferred through one or more computer systems. Certain embodiments also relate to an apparatus for performing these operations. This apparatus may be specially designed and/or constructed for the required purposes, or it may be a general-purpose computer selectively configured by one or more computer programs and/or data structures stored in or otherwise made available to the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines is shown and described below.

In addition, certain embodiments relate to computer readable media or computer program products that include program instructions and/or data (including data structures) for performing various computer-implemented operations associated with at least the following tasks: (1) obtaining raw data from instrumentation, databases (private or public (e.g., NCBI, dbSNP), and other sources, (2) curating raw data to provide feature sets, (3) importing feature sets and other data to a repository such as database or knowledge base, (4) mapping features from imported data to pre-defined feature references in an index, (5) generating a pre-defined feature index, (6) generating correlations or other scoring between feature sets and feature sets and between feature sets and feature groups, (7) creating feature groups, (8) generating concept scores or other measures of concepts relevant to features, feature sets and feature groups, (9) determining authority levels to be assigned to a concept for every feature, feature set and feature group that is relevant to the concept, (10) filtering by data source, organism, authority level or other category, (11) receiving queries from users (including, optionally, query input content and/or query field of search limitations), (12) running queries using features, feature groups, feature sets, Studies, concepts, taxonomy groups, and the like, and (13) presenting query results to a user (optionally in a manner allowing the user to navigate through related content perform related queries). The invention also pertains to computational apparatus executing instructions to perform any or all of these tasks. It also pertains to computational apparatus including computer readable media encoded with instructions for performing such tasks.

Further the invention pertains to useful data structures stored on computer readable media. Such data structures include, for example, feature sets, feature groups, taxonomy hierarchies, feature indexes, score tables, and any of the other logical data groupings presented herein. Certain embodiments also provide functionality (e.g., code and processes) for storing any of the results (e.g., query results) or data structures generated as described herein. Such results or data structures are typically stored, at least temporarily, on a computer readable medium such as those presented in the following discussion. The results or data structures may also be output in any of various manners such as displaying, printing, and the like.

Examples of displays suitable for interfacing with a user in accordance with the invention include but are not limited to cathode ray tube displays, liquid crystal displays, plasma displays, touch screen displays, video projection displays, light-emitting diode and organic light-emitting diode displays, surface-conduction electron-emitter displays and the like. Examples of printers include toner-based printers, liquid inkjet printers, solid ink printers, dye-sublimation printers as well as inkless printers such as thermal printers. Printing may be to a tangible medium such as paper or transparencies.

Examples of tangible computer-readable media suitable for use computer program products and computational apparatus of this invention include, but are not limited to, magnetic media such as hard disks, floppy disks, and magnetic tape; optical media such as CD-ROM disks; magneto-optical media; semiconductor memory devices (e.g., flash memory), and hardware devices that are specially configured to store and perform program instructions, such as read-only memory devices (ROM) and random access memory (RAM) and sometimes application-specific integrated circuits (ASICs), programmable logic devices (PLDs) and signal transmission media for delivering computer-readable instructions, such as local area networks, wide area networks, and the Internet. The data and program instructions provided herein may also be embodied on a carrier wave or other transport medium (including electronic or optically conductive pathways). The data and program instructions of this invention may also be embodied on a carrier wave or other transport medium (e.g., optical lines, electrical lines, and/or airwaves).

Examples of program instructions include low-level code, such as that produced by a compiler, as well as higher-level code that may be executed by the computer using an interpreter. Further, the program instructions may be machine code, source code and/or any other code that directly or indirectly controls operation of a computing machine. The code may specify input, output, calculations, conditionals, branches, iterative loops, etc. I general, the logic used to perform the described methods can be designed or configured in hardware and/or software. In other words, the instructions for controlling the drive circuitry may be hard coded or provided as software. In may be said that the instructions are provided by “programming”. Such programming is understood to include logic of any form including hard coded logic in digital signal processors and other devices which have specific algorithms implemented as hardware. Programming is also understood to include software or firmware instructions that may be executed on a general purpose processor.

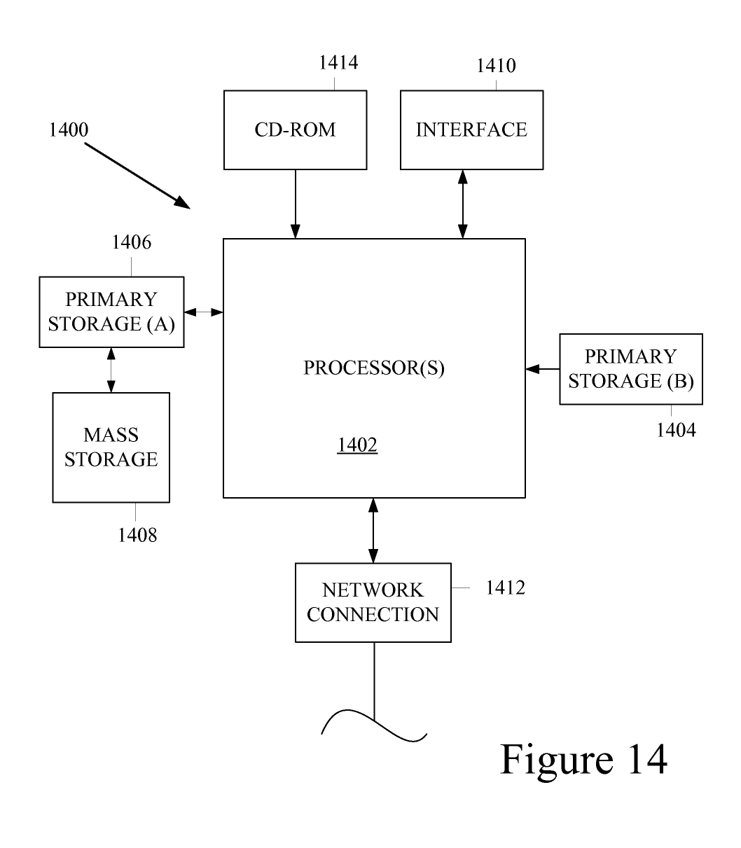

FIG. 14 illustrates, in simple block format, a typical computer system that, when appropriately configured or designed, can serve as a computational apparatus according to certain embodiments. The computer system 1400 includes any number of processors 1402 (also referred to as central processing units, or CPUs) that are coupled to storage devices including primary storage 1406 (typically a random access memory, or RAM), primary storage 1404 (typically a read only memory, or ROM). CPU 1402 may be of various types including microcontrollers and microprocessors such as programmable devices (e.g., CPLDs and FPGAs) and non-programmable devices such as gate array ASICs or general-purpose microprocessors. In the depicted embodiment, primary storage 1404 acts to transfer data and instructions uni-directionally to the CPU and primary storage 1406 is used typically to transfer data and instructions in a bi-directional manner. Both of these primary storage devices may include any suitable computer-readable media such as those described above. A mass storage device 1408 is also coupled bi-directionally to primary storage 1406 and provides additional data storage capacity and may include any of the computer-readable media described above. Mass storage device 1408 may be used to store programs, data and the like and is typically a secondary storage medium such as a hard disk. Frequently, such programs, data and the like are temporarily copied to primary memory 1406 for execution on CPU 1402. It will be appreciated that the information retained within the mass storage device 1408, may, in appropriate cases, be incorporated in standard fashion as part of primary storage 1404. A specific mass storage device such as a CD-ROM 1414 may also pass data uni-directionally to the CPU or primary storage.

CPU 2102 is also coupled to an interface 1410 that connects to one or more input/output devices such as such as video monitors, track balls, mice, keyboards, microphones, touch-sensitive displays, transducer card readers, magnetic or paper tape readers, tablets, styluses, voice or handwriting recognition peripherals, USB ports, or other well-known input devices such as, of course, other computers. Finally, CPU 1402 optionally may be coupled to an external device such as a database or a computer or telecommunications network using an external connection as shown generally at 1412. With such a connection, it is contemplated that the CPU might receive information from the network, or might output information to the network in the course of performing the method steps described herein.

In one embodiment, a system such as computer system 1400 is used as a special purpose data import, data correlation, and querying system capable of performing some or all of the tasks described herein. System 1400 may also serve as various other tools associated with knowledge bases and querying such as a data capture tool. Information and programs, including data files can be provided via a network connection 1412 for access or downloading by a researcher. Alternatively, such information, programs and files can be provided to the researcher on a storage device. In a specific embodiment, the computer system 1400 is directly coupled to a data acquisition system such as a microarray or high-throughput screening system that captures data from samples. Data from such systems are provided via interface 1410 for analysis by system 1400. Alternatively, the data processed by system 1400 are provided from a data storage source such as a database or other repository of relevant data. Once in apparatus 1400, a memory device such as primary storage 1406 or mass storage 1408 buffers or stores, at least temporarily, relevant data. The memory may also store various routines and/or programs for importing, analyzing and presenting the data, including importing feature sets, correlating feature sets with one another and with feature groups, generating and running queries, etc.

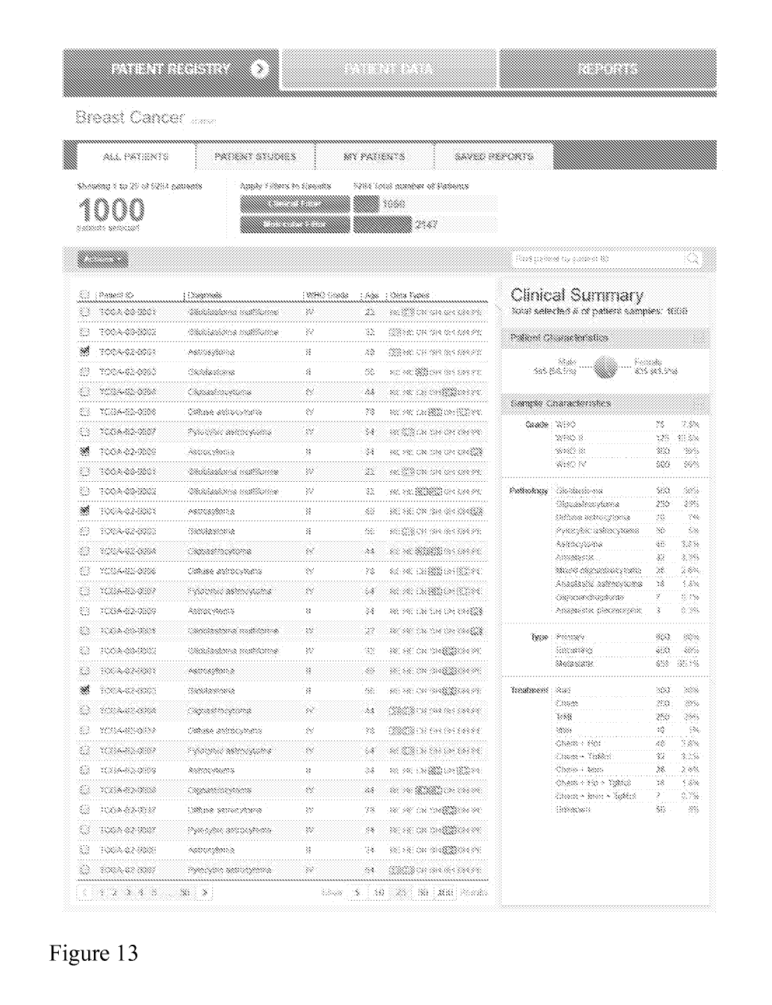

In certain embodiments user terminals may include any type of computer (e.g., desktop, laptop, tablet, etc.), media computing platforms (e.g., cable, satellite set top boxes, digital video recorders, etc.), handheld computing devices (e.g., PDAs, e-mail clients, etc.), cell phones or any other type of computing or communication platforms. A server system in communication with a user terminal may include a server device or decentralized server devices, and may include mainframe computers, mini computers, super computers, personal computers, or combinations thereof. A plurality of server systems may also be used without departing from the scope of the present invention. User terminals and a server system may communicate with each other through a network. The network may comprise, e.g., wired networks such as LANs (local area networks), WANs (wide area networks), MANs (metropolitan area networks), ISDNs (Intergrated Service Digital Networks), etc. as well as wireless networks such as wireless LANs, CDMA, Bluetooth, and satellite communication networks, etc. without limiting the scope of the present invention. In some embodiments, an interface can be provided to navigate and query the knowledge base. FIG. 13 is a screenshot showing an example of an interface.

Although the foregoing invention has been described in some detail for purposes of clarity of understanding, it will be apparent that certain changes and modifications may be practiced within the scope of the invention. It should be noted that there are many alternative ways of implementing the processes and databases of the present invention. Accordingly, the present embodiments are to be considered as illustrative and not restrictive, and the invention is not to be limited to the details given herein.

1. A computer-implemented method comprising:
receiving by one or more processors of a computer system a feature set including variants in a patients' genome;
determining an association of each variant in the received feature set with a phenotype under consideration based on information stored on one or more storage devices; and
determining, by one or more processors, an indication of the likelihood the patient will be susceptible to the phenotype under consideration based on the determined associations.

2. The computer-implemented method of claim 1, wherein the information comprises variant-gene mapping information.

3. The computer-implemented method of claim 1, wherein the information comprises variant information from at least thousands of other patients.
